(19) United States
(12) Patent Application Publication
(10) Pub. No.: US 2017/0300632 A1
(43) Pub. Date: Oct. 19, 2017

(54) MEDICAL HISTORY EXTRACTION USING STRING KERNELS AND SKIP GRAMS

(71) Applicant: NEC Laboratories America, Inc., Princeton, NJ (US)

(72) Inventor: Bing Bai, Princeton Junction, NJ (US)

(21) Appl. No.: 15/489,023

(22) Filed: Apr. 17, 2017

Related U.S. Application Data
(60) Provisional application No. 62/324,513, filed on Apr. 19, 2016.

(51) Int. Cl. G06F 19/00; G06N 99/00; G06F 17/27

(52) U.S. Cl. CPC G06F 19/322; G06F 17/2775; G06N 99/005

(57) ABSTRACT

Systems and methods for document analysis include identifying candidates in a corpus matching a requested expression. String kernel features are extracted for each candidate. Each candidate is classified according to the string kernel features using a machine learning model. A report is generated that identifies instances of the requested expression in the corpus that match a requested class.

### RELATED APPLICATION INFORMATION

This application claims priority to U.S. Patent Application No. 62/324,513 filed on Apr. 19, 2016, incorporated herein by reference in its entirety.

### BACKGROUND

### Technical Field

The present invention relates to natural language processing and, more particularly, to the extraction and categorization of information in patient medical histories.

### Description of the Related Art

Electronic medical records are becoming a standard in maintaining healthcare information. There is a great deal of information in such records that can potentially help medical scientists, doctors, and patients to improve the quality of care. However, going through large volumes of electronic medical records and finding the information of interest can be an enormous undertaking.

One challenge in mining medical records is that a significant amount of data is stored as unstructured natural language text, which depends on the unsolved problem of natural language understanding. Furthermore, the information may be recorded in a relatively informal way, using incomplete sentences, jargon, and unmarked data, making it difficult to use general purpose natural language processing solutions.

### SUMMARY

A method for document analysis includes identifying candidates in a corpus matching a requested expression. String kernel features are extracted for each candidate. Each candidate is classified according to the string kernel features using a machine learning model. A report is generated that identifies instances of the requested expression in the corpus that match a requested class.

A system for document analysis includes a feature extraction module configured to identify candidates in a corpus matching a requested expression and to extract string kernel features for each candidate. A classifying module has a processor configured to classify each candidate according to the string kernel features using a machine learning model. A report module is configured to generate a report that identifies instances of the requested expression in the corpus that match a requested class.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of a method for analyzing text documents in accordance with one embodiment of the present invention;

FIG. 2 is a block/flow diagram of a method for training a machine learning model for analyzing text documents in accordance with one embodiment of the present invention;

FIG. 3 is a block diagram of a medical record analysis system in accordance with one embodiment of the present invention; and

FIG. 4 is a processing system in accordance with one embodiment of the present invention.

### DETAILED DESCRIPTION OF PREFERRED EMBODIMENTS

Embodiments of the present invention perform natural language processing of documents such as electronic medical records, classifying particular features according to one or more categories. To accomplish this, the present embodiments use processes described herein, including string kernels and skip-grams. In particular embodiments, electronic medical records are used to extract a patient's medical history, differentiating such information from other types of information.

The medical history is one of the most important types of information stored in electronic medical records, relating to the diagnoses and treatments of a patient. Extracting such information greatly reduces the time a medical practitioner needs to review the medical records. The present embodiments provide, e.g., disorder identification by not only extracting mentions of a disorder from the medical records, but also making distinctions between mentions relating specifically to the patient and mentions relating to others. This problem arises because a disorder can be mentioned for various reasons, not just relating to medical conditions of a patient, but also including medical conditions that the patient does not have, the medical history of the patient's family members, and other cases such as the description of potential side effects. The present embodiments distinguish between these different uses.

Toward that end, the present embodiments make use of rule-based classification and machine learning. A string kernel process is used on raw record text. Machine learning is then used to classify the output of the string kernel process to classify a given disorder mention with respect to whether or not the mention relates to a disorder that the patient has.

It should be noted that, although the present embodiments are described with respect to the specific context of processing electronic medical records, they may be applied with equal effectiveness to any type of unstructured text. The present embodiments should therefore not be interpreted as being limited to any particular document format or content.

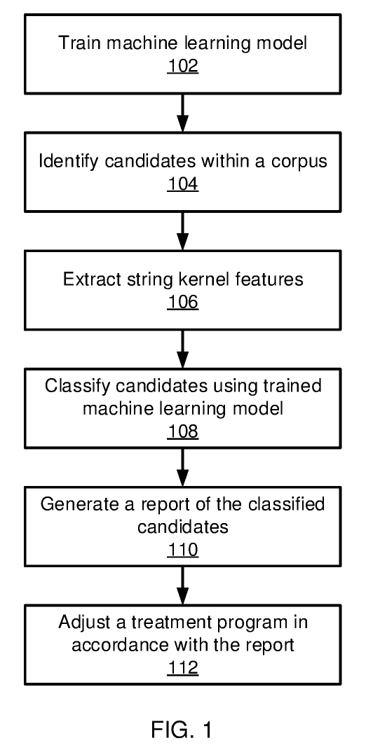

Referring now in detail to the figures in which like numerals represent the same or similar elements and initially to FIG. 1, a high-level system/method for natural language processing is illustratively depicted in accordance with one embodiment of the present principles. Block 102 trains a machine learning model. This training process will be described in greater detail below and creates a classifier that distinguishes between different categories for a candidate word or phrase based on extracted string kernel features.

Block 104 identifies candidates within a corpus. It is specifically contemplated that the corpus may include the electronic medical records pertaining to a particular patient, but it should be understood that other embodiments may include documents relating to entirely different fields. The “candidates” that are identified herein may, for example, be the name of a particular disorder, disease, or condition and may be identified as a simple text string or may include, for example, wildcards, regular expressions, or other indications of a pattern to be matched. In another embodiment, the expression to match may include a list of words relating to a single condition, where matching any word will identify a candidate. The identification of candidates in block 104 may simply traverse each word of the corpus to find matches—either exact matches or matches having some similarity to the searched-for expression. The identification of candidates in block 104 may furthermore identify a “window” of text around each candidate, associating those text windows with the respective candidates.

Block 106 extracts string kernel features. The extraction of string kernel features may, in certain embodiments, extract n-grams or skip-n-grams. As used herein, an n-gram is a sequence of consecutive words or other meaningful elements or tokens. As used herein, a skip-n-gram or a skip-gram is a sequence of words or other meaningful elements which may not be consecutive. In other words, a skip-2-gram, may identify a first and a second word, but may match phrases that include other words between the first and second word. There may be a maximum matching distance for a skip-n-gram, where the words or tokens may not be separated by more than the maximum number of other words or tokens. In alternative embodiments, the skip-n-gram may have forbidden symbols or tokens. For example, the skip-n-gram may not match strings of words that include a period, such that the skip-n-gram would not match strings that extend between sentences.

The string kernel features extracted by block 106 represent heuristics on how two sequences should be similar. In one example using sparse spatial kernels, the score for two sequences X and Y from a sample dataset can be defined as:

$${K}^{( t , k , d )} ( X , Y ) = {\sum }_{{a}_{i} ∈ {Σ}^{k} , 0 \leq {d}_{i} < d} {C}_{X} ( {a}_{1} , {d}_{1} , … , {a}_{t - 1} , {d}_{t - 1} , {a}_{t} ) {C}_{Y} ( {a}_{1} , {d}_{1} , … , {a}_{t - 1} , {d}_{t - 1} , {a}_{t} )$$

where t is the number of k-grams, aᵢ is the i^{th} k-grams, separated by dᵢ<d words in the sequence, C_{X} and C_{Y} are counts of such units in X and Y respectively, and X and Y are any appropriate sequence (such as, e.g., text strings or gene sequences). In one illustrative example, if t=2, k=1, and d=2, two sequences would be X=“ABC” and Y=“ADC”. The count C_{X} (“A”, 1, “C”)=1 and C_{Y} (“A”, 1, “C”)=1, thus K^{(1,1,2)}(X,Y)=1·1=1.

One variation with relaxed distance requirements is expressed as:

$${K}_{r}^{( t , k , d )} ( X , Y ) = {\sum }_{{a}_{i} ∈ {Σ}^{k} , 0 \leq {d}_{i} < d , 0 \leq {d}_{i}^{′} < d} {C}_{X} ( {a}_{1} , {d}_{1} , … , {a}_{t - 1} , {d}_{t - 1} , {a}_{t} ) {C}_{Y} ( {a}_{1} , {d}_{1}^{′} , … , {a}_{t - 1} , {d}_{t - 1}^{′} , {a}_{t} )$$

In this example, K^{(1,1,2)}(“ABC”, “AC”)=0, but in its relaxed version, Kᵣ^{(1,1,2,2)}(“ABC”, “AC”)=1. Intuitively, this adaptation enables the model to match phrases like, “her mother had . . . ” and “her mother earlier had.” The relaxed version thereby implements skip-n-grams.

Although it is specifically contemplated that string kernels may be used for feature extraction, other types of feature extraction are contemplated. For example, a “bag of words” approach can be used instead. Indeed, any appropriate text analysis may be used for feature extraction, with the proviso that overly detailed feature schemes should be avoided. This helps maintain generality when extracting features from a heterogeneous set of documents.

Block 108 classifies the candidates using the features extracted by block 106 using the trained machine learning model. It should be understood that a variety of machine learning processes may be used to achieve this goal. Examples include a support vector machine (SVM), logistic regression, and decision trees. SVM is specifically addressed herein, but any appropriate machine learning model may be used instead.

Block 110 generates a report based on the classified candidates. For example, if the user's goal is to identify points in the electronic medical records that describe a particular condition that the patient has, the report may include citations or quotes from the electronic medical record that will help guide the user to find the passages of interest. Block 112 then adjusts a treatment program in accordance with the report. For example, if the report indicates that the user has or is at risk for a particular disease, particular drugs or treatments may be contraindicated. Block 112 may therefore raise a flag for a doctor or may directly and automatically change the treatment program if a proposed treatment would pose a risk to the patient.

In one application of the present embodiments, a doctor could use the generated report to rapidly determine whether the user has a particular condition. The patient's general medical history can be rapidly extracted as well by finding all conditions that are classified as pertaining to the patient. A further application can be to help identify potential risk factors, for example by determining if the patient smokes or has high blood pressure.

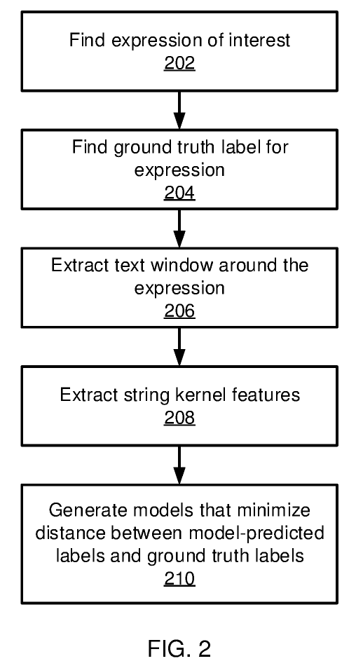

Referring now to FIG. 2, a method for training a machine learning model is shown, providing greater detail on block 102. Block 202 finds an expression of interest within a training corpus. The expression is labeled for its “ground truth” in block 204. This ground truth represents its category. Following the example of identifying conditions pertaining to a patient in electronic medical records, this ground truth may categorize the expression with respect to whether it pertains to a condition of the patient, a condition of the patient's family, etc. The identification of the ground truth label may be performed manually, for example by a person having domain knowledge.

Block 206 extracts the text window around the expression of interest. This may include, for example, extracting a number of words or tokens before and after the expression of interest, following the rationale that words close to the expression of interest are more likely to be pertinent to its label. Block 208 extracts string kernel features for the expression as described above.

Block 210 generates machine learning models. The training process aims to minimize a distance between the predicted labels generated by a given model and the ground truth labels. Following the specific example of SVM learning, given a set of n training samples:

{(xᵢ,yᵢ)|xᵢε [symbol] ^{p},yᵢε(−1,1}}ᵢ₌₁ⁿ

where xᵢ is the p-feature vector of the i^{th} training sample and yᵢ is the label of whether the sample is positive or negative, and [symbol] ^{p} is a p-dimensional space. A vector in [symbol] ^{p} can be represented as a vector of p real numbers. Each feature is a component of the vector in [symbol] ^{p}. SVM fins a weight vector w and a bias b that minimizes the following loss function:

$${min}_{w , b} τ ( w ) = \frac{1}{2} {‖ w ‖}^{2} + C {\sum }_{i = 1}^{n} {ξ}_{i}$$

$$s . t . {y}_{i} ( {w}^{T} {x}_{i} ) + b \geq 1 - {ξ}_{i} , i ∈ [ 1 , n ]$$

SVM is a linear boundary classifier, where a decision is made on a linear transformation with parameters w and b. An advantage of SVM over traditional linear methods like the perceptron method is the regularization (reducing the norm of w) helps SVM avoid overfitting when training data is limited.

The dual form of SVM can also be useful where, instead of optimizing the weight vector w, the dual form introduces dual variables αᵢ for each data example. The direct linear projection wx is replaced with a function K(xᵢ, x₁) that has more flexibility and, thus, is potentially more powerful. The dual SVM can be described as:

$$max {\sum }_{i = 1}^{n} {α}_{i} - \frac{1}{2} {\sum }_{i , j} {α}_{i} {α}_{j} {y}_{i} {y}_{j} K ( {x}_{i} , {x}_{j} )$$

$$s . t . 0 \leq {α}_{i} \leq C , {\sum }_{i = 1}^{n} {α}_{i} {y}_{i} = 0$$

Block 210 may use any appropriate learning mechanism to refine the machine-learning models. In general, block 210 will adjust the parameters of the models until a difference or distance function that characterizes differences between the model's prediction and the known ground truth label is minimized.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

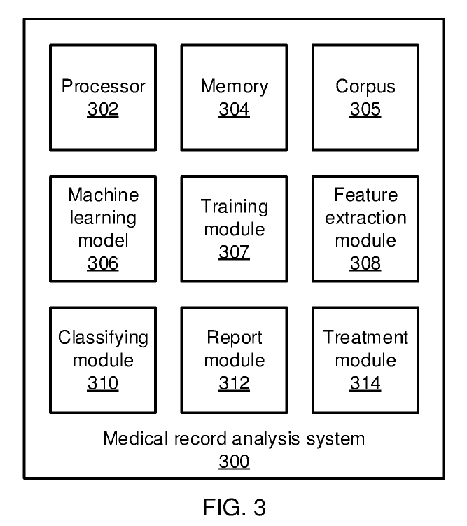

Referring now to FIG. 3, a system for medical record analysis 300 is shown. The system 300 includes a hardware processor 302 and a memory 304. The memory 304 stores a corpus 305 of documents which in some embodiments include electronic medical records. The corpus 305 may include the medical records pertaining to a specific patient or to many patients. The system 300 also includes one or more functional modules. In some embodiments, one or more of the functional modules may be implemented as software that is stored in the memory 304 and is executed by the hardware processor 302. In alternative embodiments, one or more of the functional modules may be implemented as one or more discrete hardware components in the form of, e.g., application-specific integrated chips or field programmable gate arrays.

A machine learning model 306 is trained and stored in memory 304 by training module 307 using a corpus 305 that includes heterogeneous medical records from many patients. When information regarding a specific patient is requested, feature extraction module 308 locates candidates relating to a particular expression in a corpus 305 pertaining to that specific patient. Classifying module 310 then classifies each candidate according to the machine learning model 306.

Based on the classified candidates, report module 312 generates a report responsive to the request. In one example, if the patient's medical history is requested, the report module 312 finds includes candidates that are classified as pertaining to descriptions of the patient (as opposed to, e.g., descriptions of the patient's family or descriptions of conditions that the patient does not have).

A treatment module 314 changes or administers treatment to a user based on the report. In some circumstances, for example when a treatment is prescribed that is contraindicated by some information in the user's medical records that may have been missed by the doctor, the treatment module 314 may override or alter the treatment. The treatment module 314 may use a knowledge base of existing medical information and may apply its adjusted treatments immediately in certain circumstances where the patient's life is in danger.

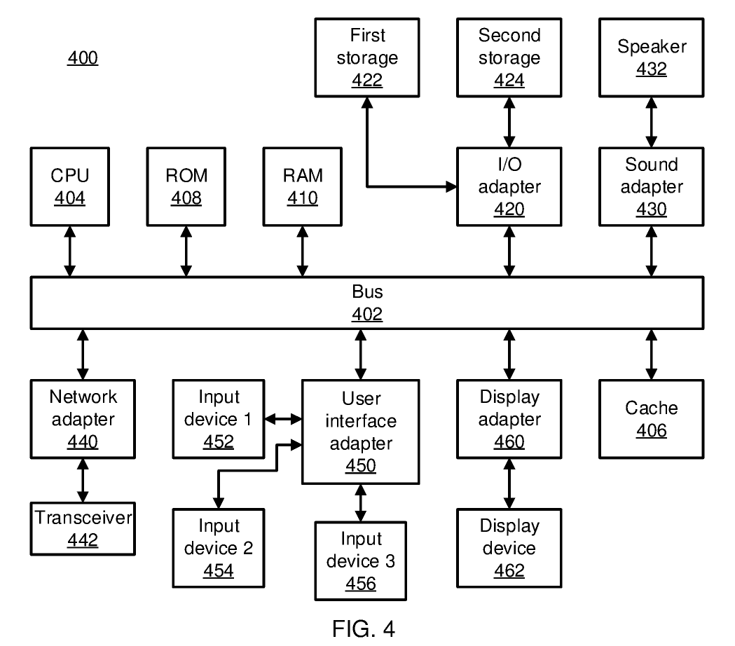

Referring now to FIG. 4, an exemplary processing system 400 is shown which may represent the medical record analysis system 300. The processing system 400 includes at least one processor (CPU) 404 operatively coupled to other components via a system bus 402. A cache 406, a Read Only Memory (ROM) 408, a Random Access Memory (RAM) 410, an input/output (I/O) adapter 420, a sound adapter 430, a network adapter 440, a user interface adapter 450, and a display adapter 460, are operatively coupled to the system bus 402.

A first storage device 422 and a second storage device 424 are operatively coupled to system bus 402 by the I/O adapter 420. The storage devices 422 and 424 can be any of a disk storage device (e.g., a magnetic or optical disk storage device), a solid state magnetic device, and so forth. The storage devices 422 and 424 can be the same type of storage device or different types of storage devices.

A speaker 432 is operatively coupled to system bus 402 by the sound adapter 430. A transceiver 442 is operatively coupled to system bus 402 by network adapter 440. A display device 462 is operatively coupled to system bus 402 by display adapter 460.

A first user input device 452, a second user input device 454, and a third user input device 456 are operatively coupled to system bus 402 by user interface adapter 450. The user input devices 452, 454, and 456 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 452, 454, and 456 can be the same type of user input device or different types of user input devices. The user input devices 452, 454, and 456 are used to input and output information to and from system 400.

Of course, the processing system 400 may also include other elements (not shown), as readily contemplated by one of skill in the art, as well as omit certain elements. For example, various other input devices and/or output devices can be included in processing system 400, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 400 are readily contemplated by one of ordinary skill in the art given the teachings of the present principles provided herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for document analysis, comprising
identifying candidates in a corpus matching a requested expression;
extracting string kernel features for each candidate;
classifying each candidate according to the string kernel features using a machine learning model; and
generating a report that identifies instances of the requested expression in the corpus that match a requested class.

2. The method of claim 1, wherein extracting the string kernel features comprises multiplying together counts of word occurrences for two sequences of words.

3. The method of claim 2, wherein the counts of word occurrences exclude occurrences that do not match a distance criterion.

4. The method of claim 2, wherein the counts of word occurrences have a relaxed distance criterion.

5. The method of claim 4, wherein a score for a pair of sequences X and Y is determined as:
$${K}_{r}^{( t , k , d )} ( X , Y ) = {\sum }_{{a}_{i} ∈ {Σ}^{k} , 0 \leq {d}_{i} < d , 0 \leq {d}_{i}^{′} < d} {C}_{X} ( {a}_{1} , {d}_{1} , … , {a}_{t - 1} , {d}_{t - 1} , {a}_{t} ) {C}_{Y} ( {a}_{1} , {d}_{1}^{′} , … , {a}_{t - 1} , {d}_{t - 1}^{′} , {a}_{t} )$$
where t is a number of k-grams, a₁ is the i^{th} k-gram, dᵢ is a distance in words between two k-grams, sequence a₁, d₁, . . . , aₜ₋₁, dₜ₋₁, aₜ is a skip-gram, and C_{X} and C_{Y} are counts of corresponding skip-grams in text strings X and Y respectively.

6. The method of claim 1, further comprising training the machine learning model based on predetermined ground truth values for a set of expressions.

7. The method of claim 6, wherein the machine learning model is based on support vector machine learning.

8. The method of claim 1, wherein the corpus comprises electronic medical records for a single patient.

9. The method of claim 8, classifying each candidate comprises determining whether the expression describes a condition of the patient.

10. The method of claim 8, wherein generating the report comprises generating a medical history of the patient.

11. A system for document analysis, comprising
a feature extraction module configured to identify candidates in a corpus matching a requested expression and to extract string kernel features for each candidate;
a classifying module comprising a processor configured to classify each candidate according to the string kernel features using a machine learning model; and
a report module configured to generate a report that identifies instances of the requested expression in the corpus that match a requested class.

12. The system of claim 11, wherein the feature extraction module is further configured to multiply multiplying together counts of word occurrences for two sequences of words.

13. The system of claim 12, wherein the counts of word occurrences exclude occurrences that do not match a distance criterion.

14. The system of claim 12, wherein the counts of word occurrences have a relaxed distance criterion.

15. The system of claim 14, wherein a score for a pair of sequences X and Y is determined as:
$${K}_{r}^{( t , k , d )} ( X , Y ) = {\sum }_{{a}_{i} ∈ {Σ}^{k} , 0 \leq {d}_{i} < d , 0 \leq {d}_{i}^{′} < d} {C}_{X} ( {a}_{1} , {d}_{1} , … , {a}_{t - 1} , {d}_{t - 1} , {a}_{t} ) {C}_{Y} ( {a}_{1} , {d}_{1}^{′} , … , {a}_{t - 1} , {d}_{t - 1}^{′} , {a}_{t} )$$
where t is a number of k-grams, aᵢ is the i^{th} k-gram, dᵢ is a distance in words between two k-grams, sequence a₁, d₁, . . . , aₜ₋₁, dₜ₋₁, aₜ is a skip-gram, and C_{X} and C_{Y} are counts of corresponding skip-grams in text strings X and Y respectively.

16. The system of claim 11, further comprising a training module configured to train the machine learning model based on predetermined ground truth values for a set of expressions.

17. The system of claim 16, wherein the machine learning model is based on support vector machine learning.

18. The system of claim 11, wherein the corpus comprises electronic medical records for a single patient.

19. The system of claim 18, wherein the classifying module is further configure to determine whether the expression describes a condition of the patient.

20. The system of claim 18, wherein the report module is further configured to generate a medical history of the patient.
